(19) United States
(12) Patent Application Publication
(10) Pub. No.: US 2006/0280923 A1
(43) Pub. Date: Dec. 14, 2006

(54) Controlled multilayer degradable film

(76) Inventors: Jodi Fleck-Arnold, Bloomington, IN (US); Mark Jordan, Chesterbrook, PA (US)

Correspondence Address: MCANDREWS HELD & MALLOY, LTD, 500 WEST MADISON STREET, SUITE 3400, CHICAGO, IL, 60661, US

(21) Appl. No.: 11/148,698

(22) Filed: Jun. 9, 2005

(51) Int. Cl. A01G 7/00; B32B 27/08; B32B 27/32

(52) U.S. Cl. 428/220; 428/523; 428/516; 428/339; 47/9

(57) ABSTRACT

The present invention relates to multilayer degradable films for covering soil for use in cropping or covering a frame in order to achieve a greenhouse effect. In particular, the present invention is directed to a polyolefin film having a degradable component wherein degradation is activated by both ultraviolet and thermal triggers. More particularly, the degradable polyolefin film of the present invention changes color through selective layer degradation to suit the season and geographic location of the area being covered.

### BACKGROUND OF THE INVENTION

The present invention relates to multilayer degradable films for covering soil for use in cropping or covering a frame in order to achieve a greenhouse effect. In particular, the present invention is directed to a polyolefin film having a degradable component wherein degradation is activated by both ultraviolet and thermal triggers. More particularly, the degradable polyolefin film of the present invention changes color through selective layer degradation to suit the season and geographic location of the area being covered.

In agriculture, wide use is made of crop protection or mulching films. Such films desirably cover, enclose or protect the soil and/or the growing crops under fully exposed outdoor conditions for a given period of time or time of year. Conventional methods use a thin plastic film layered on the cultivated soil, the soil having already been seeded or being seeded or transplanted concurrently with the cultivation of the soil, or seeded or transplanted at a later date through the plastic already laid after the plastic has been placed in the field (may not be just for warming—could be other reasons for pre-laying of the film). With conventional plastic cover techniques it is possible to cultivate the soil and apply the plastic film simultaneously with existing machinery. Such techniques allow the earlier germination of seeds and provide protection for the seedlings from late season frosts, but which will not impede growth of the seedlings beyond the initial germination stages. In addition, the film can be used in conventional greenhouse-like structures or as a mulch film.

Conventional degradable films are generally UV photo-triggered. The rate of degradation is difficult to control because the edges of the film tend to degrade at a slower rate than the center portions of the film due to the limited solar exposure—particularly along the buried edges of the mulch films. In conventional degradable agricultural films, the degradation rate is very dependent upon the exposure conditions of sunlight, rainfall, and geographic location. A need in the art therefore exists for a degradable film with a rate of degradation that is more easily controlled through the seasons and in various geographic locations based on a more reliable trigger mechanism. Further, a need in the art exists for a film that may be used for several growing seasons rather than requiring replacement each season which is both costly and time-consuming.

### BRIEF SUMMARY OF THE INVENTION

The multilayer film of the present invention includes at least one first layer composed of at least one polyolefin polymer and at least one degradable additive. In particular, the present invention is directed to a polyolefin polymer/degradable additive combination that results in an agricultural film capable of composting or degrading in a semi-predictable manner. The film of the present invention is preferably both photodegradable and thermally degradable and, therefore, environmentally degradable under most conditions. The triggered degradation that occurs is controlled by the selection of polyolefin resins, the specific additives and the concentration of the additives. The degradation may be accelerated by heat and/or solar exposure. In addition, the plastic product may degrade without sunlight, and even under anaerobic conditions, when heated to certain temperatures found in some agricultural environments including baling and composting. The multilayer degradable film of the present invention will enable growers to place film in a field a single time whereby the film will last over the course of more than one season and may change color by selective layer degradation to suit the season and geographic region.

### DETAILED DESCRIPTION OF THE INVENTION

The multilayer film of the present invention has a structure that includes at least one layer composed of at least one polyolefin polymer and at least one degradable additive. The total thickness of the film and its independent layers may vary and depends on the intended application for the film and the number of layers employed. The preferred film has a total thickness up to about 15 mils and, more preferably, from about 0.5-15 mils or any other thickness range contained therein. The thickness of each separate layer is preferably from about 0.1-15.0 mils, more preferably from about 0.5-7.0 mils, and most preferably from about 1.0-5.0 mils. It will be appreciated by those skilled in the art that the thickness of each individual layer may be similar or different in addition to having similar or different compositions. The thickness of each layer is therefore independent and may vary within the parameters set by the total thickness of the film.

The multilayer film of the present invention may be produced by conventional methods used in producing multilayer films including coextrusion and extrusion lamination techniques of blown, smooth cast, or cast embossed manufacturing processes. In the most preferred method, at least two of the layers of the film is formed by coextrusion. Melted and plasticated streams of the individual layer materials are fed into a coextrusion die. While in the die, the layers are juxtaposed and combined then emerge from the die a single multiple layer film of polymeric material. Suitable coextrusion techniques are more fully described in U.S. Pat. Nos. 5,139,878 and 4,677,017, incorporated herein by reference to the extent permitted by law, except that coextrusion of the present invention may be conducted at temperatures at from about 350° F. to about 550° F. Coextrusion techniques include the use of a feed block with a standard die, a multi-manifold die such as a circular die, as well as a multi-manifold die such as used in forming flat cast films and cast sheets. The multilayer films of the present invention may also be preferably made by blown film coextrusion. The film is formed using a blown film apparatus composed of a multi-manifold circular die head having concentric circular orifices. The multilayer film is formed by coextruding a molten layer through a circular die, and a molten layer on the other or each opposite side of the first layer through additional circular dies concentric with the first circular die. Then a gas, typically air, is blown through a jet that is concentric with the circular dies thereby forming a bubble expanding the individual layers. The bubble is then collapsed upon itself into a pair of attached multilayer films attached at two opposite edges. Usually, the pair of attached multilayer films are then cut apart at one or more of the edges and separated into a pair of multilayer films that may then be rolled up.

In the preferred film, at least one layer is composed of from about 0.5-99% by weight, more preferably from about 50-99% by weight, more preferably from about 70-99% by weight, and most preferably from about 90-99%, of at least one polyolefin polymer. Preferred polyolefin polymers include polyethylene, polypropylene, polybutenes, polyisoprene, copolymers thereof, terpolymers thereof, a-olefin propylene copolymers, metallocene-catalyzed polyolefin resins, and mixtures thereof. Suitable polyethylenes include, in particular, low density polyethylene (LDPE), high density polyethylene (HDPE), linear low density polyethylene (LLDPE), and ultra low density polyethylene (ULDPE). Preferred propylene polymers generally contain from about 90-100% by weight of propylene units and the preferred propylene polymers generally have a melting point of 130° C. or above. Preferred propylene polymers generally have a melt flow index of from 0.5 g/10 min to 100 g/10 min at 230° C. and a force of 21.6 N. Isotactic propylene homopolymer having an n-heptane-soluble content of from about 1-15% by weight, copolymers of ethylene and propylene having an ethylene content of 10% by weight or less, copolymers of propylene with C₄-C₈ α-olefins having an α-olefin content of 10% by weight or less, and terpolymers of propylene, ethylene and butylene having an ethylene content of 10% by weight or less and a butylene content of 15% by weight or less are preferred propylene polymers. Also suitable is a mixture of propylene homopolymers, copolymers, terpolymers and other polyolefins. Preferred metallocenes are single site catalysts and include dicyclopentadienyl-metals and -metal halides. A preferred polyolefin polymer is an ethylene-based polymer such as a hexene or octene copolymer produced with metallocene single site catalysts. Most preferred is metallocene linear low density polyethylene (mLLDPE) and metallocene low density polyethylene (mLDPE). The preferred mLLDPE and mLPDE have a density of about 0.93 g/cm³ or less. Preferred ethylene copolymer resins include ethylene vinyl acetate copolymer resins (EVA), ethylene methyl acrylate copolymer resins (EMA), and mixtures thereof.

The preferred degradable or compostable additives are present in the at least one layer in an amount of from about 0.1-49% by weight, more preferably from about 0.1-10%, most preferably 0.1-5%, and any other range contained therein. The preferred degradable additive is a combination of a metal carboxylate and an aliphatic poly hydroxy-carboxyl acid. The preferred metal carboxylates are cobalt, cerium and iron stearate. Other suitable metal carboxylates are carboxylates containing aluminum, antimony, barium, bismuth, cadmium, chromium, copper, gallium, lanthanum, lead, lithium, magnesium, mercury, molybdenum, nickel, potassium, rare earths, silver, sodium, strontium, tin, tungsten, vanadium, yttrium, zinc or zirconium. An aliphatic poly hydroxy-carboxyl acid is an aliphatic acid having either more than one hydroxy (—OH) or more than one carboxyl (—COOH) group in the organic acid. The aliphatic poly hydroxy-carboxyl acids are illustrated by the aliphatic, dihydroxy, monocarboxyl acids, such as glyoxylic acid and glyceric acid; the aliphatic, polyhydroxy, monocarboxyl acids, such as erythric acid, arabic acid or mannitic acid; the aliphatic, monohydric, dicarboxyl acids, such as tartronic acid or malic acid; the aliphatic, dihydroxy, dicarboxyl acids, such as tartaric acid; the aliphatic, polyhydroxy, dicarboxyl acids, such as trihydroxyglutaric acid and succharic acid; and the aliphatic, monohydroxy, tricarboxyl acids, such as citric acid. The degradable additive of the present invention include a combination of the metal carboxylates, an aliphatic poly hydroxy-carboxyl acid, calcium oxide, and other suitable compounds. A preferred degradable additive is sold under the Envirocare trademark by Ciba Specialty Chemicals under license from EPI Environmental Technologies, but any other suitable degradable additive may be used and is within the scope of the invention. It is also contemplated by the invention that nutrients, such as trace elements, and fertilizers may be added to the at least one first layer. As the film degrades, such nutrients or fertilizers will aid the growth of the crop. In addition, the preferred layer may also contain colorants, stabilizers, oxidizers, antioxidants, slips, antiblocks, or calcium oxide which can change the triggering of the degradable/compostable reactions of the film layer under aerobic or anaerobic conditions.

The preferred at least one layer of the present invention also includes at least one colorant. In a preferred multilayer embodiment, a first layer contains a different colorant than that in a second layer. In another preferred multilayer embodiment, a first contains a different colorant than that in a second layer which is different from that in a third layer and so on. It will be appreciated by those skilled in the art that a multilayer agricultural film of this type could contain up to 10 layers or more. From about 0.1-49% by weight, more preferably from about 0.1-10%, most preferably 0.1-5%, and any other range contained therein, of colorants may be added. A color concentrate may be added to the layer to yield a colored layer, an opaque layer, or a translucent layer. Preferred color concentrates include color formulations including black, white, red, blue, yellow, green, orange and other colors suitable for agricultural films such as those manufactured by Ampacet Corporation (Tarrytown, N.Y.). Preferred color concentrates include Ampacet® white PE masterbatch, the carrier resin of which being a LLDPE having a melt index of 20 g/10 min and a density of .92 gm/cc and the concentrate of which has a nominal specific gravity of 2.06, a melt index of 3-23 g/10 min and nominally contains 75% ash. Another preferred color concentrate includes Ampacet® white HDPE masterbatch, the carrier resin of which being a HD/LLDPE having a nominal melt index of 10 g/10 min and a density of 0.96 gm/cc. The concentrate has a nominal specific gravity of 1.54, a melt index of 9-15 g/10 min, and a pigment composed of 50% TiO₂.

It will be appreciated by those skilled in the art that other additives may be added to the first layer or to one or more other layers of the film of the present invention in order to improve certain characteristics of the particular layer. From about 0-80% by weight of the preferred first layer or other individual layer, more preferably about 5%, of one or more additives may be added. Preferred additives include neutralizers, process aids, lubricants, stabilizers, hydrocarbon resins, antistatics, antiblocking agents, slip agents, fillers, ultraviolet stabilizers and other specialty additives suitable for use in specific applications. Suitable neutralizers include calcium carbonate and calcium stearate. Preferred neutralizers have an absolute particle size of less than 10 μm and a specific surface area of at least 40 m²/g. Polymeric processing aids may also be used in a layer. Fluoropolymers, fluoropolymer blends, and fluoroelastomers are particularly preferred, but any processing aid known in the art for use in polymer films would be suitable. A particularly preferred processing aid is Ampacet® Process Aid PE masterbatch having a LLDPE carrier resin with a nominal melt index of 2 g/10 min and a density of 0.918 gm/cc. The concentrate therein has a nominal specific gravity of 0.91, a nominal melt index of 1-3 g/10 min, and contains 3% ash.

Lubricants that may be used in accordance with the present invention include higher aliphatic acid esters, higher aliphatic acid amides, metal soaps, polydimethylsiloxanes, and waxes. Conventional stabilizing compounds for polymers of ethylene, propylene, and other α-olefins are preferably employed in the present invention. In particular, alkali metal carbonates, alkaline earth metal carbonates, phenolic stabilizers, alkali metal stearates, and alkaline earth metal stearates are preferentially used as stabilizers for the composition of the present invention.

Hydrocarbon resins and, in particular, styrene resins, terpene resins, petroleum resins, and cyclopentadiene resins have been found to be suitable as additives in order to improve desirable physical properties of the film. These properties may include water vapor permeability, shrinkage, film rigidity and optical properties. In particular, adhesive resins are preferred. A particularly preferred adhesive resin is sold under the trademark Bynel® by DuPont Corporation and is primarily composed of maleic anhydride modified polyolefin with some residual maleic anhydride and may also contain small amounts of stabilizers, additives and pigments.

Preferred antistatics include substantially straight-chain and saturated aliphatic, tertiary amines containing an aliphatic radical having 10-20 carbon atoms that are substituted by ω-hydroxy-(C₁-C₄)-alkyl groups, and N,N-bis-(2-hydroxyethyl)alkylamines having 10-20 carbon atoms in the alkyl radical. Other suitable antistatics include ethyoxylated or propoxylated polydiorganosiloxanes such as polydialkysiloxanes and polyalkylphenylsiloxanes, and alkali metal alkanesulfonates.

Preferred antiblocking agents include organic polymers such as polyamides, polycarbonates, polyesters. Other preferred agents include calcium carbonate, aluminum silicate, magnesium silicate, calcium phosphate, silicon dioxide, and diatomaceous earth.

Preferred fillers include inorganic carbonate, synthetic carbonates, nepheline syenite, talc, magnesium hydroxide, aluminum trihydrate, diatomaceous earth, mica, natural or synthetic silicas, calcined clays and mixtures thereof. Preferred fillers have a particle size less than 150 mesh and are preferably free of water. Accordingly, preferred fillers may be treated with organic acids to assist the processability of the carbonate and produce a more hydrophobic filler product. Acids such as stearic or oleic acid are conventional acids for surface treating the carbonates or other fillers.

Ultraviolet stabilizer concentrates may also preferably be used to selectively extend the useful life of the inventive film when it is exposed to the damaging effects of sunlight. UV inhibitors protect the film layers by interfering with the free radical decomposition of the polymer molecules. UV absorbers will convert harmful UV radiation into heat. The amount of UV stabilizer concentrates used in the preferred film of the present invention may vary layer by layer such that the individual layers degrade at different rates.

In a preferred embodiment of the film of the present invention described hereinabove, the film structure is a two-layer structure wherein a first layer contains a different colorant additive than a second layer. It will be appreciated by those skilled in the art that additional layers could be added to the film to form a film having up to ten layers. At least one adhesive tie layer may also be provided between layers to provide sufficient adhesion.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLE 1

A two-layer film having a total film thickness of 0.88 mils was produced using the formula set forth in Table 1.

TABLE 1
Formulation 1 - 2 Layer Film Formulation

| | Layer | | | | | Melt | | |
|---|---|---|---|---|---|---|---|---|
| Layer | Thickness | Ratio | Supplier | ID | Type | Index | Density | Content % |
| A | 0.748 mils | 85% | Ampacet | 511688 | White UV | 2.8 | 1.859 | 22.0 |
| | | | Ampacet | 100458 | Process | 2.5 | 0.960 | 0.5 |
| | | | | | Aid | | | |
| | | | Ampacet | 10545 | Slip AB | 9.5 | 0.928 | 2.0 |
| | | | Ampacet | 100840 | UVI/AO | 9.1 | 0.808 | 1.5 |
| | | | Ampacet | 10126 | Antiblock | 1.1 | 1.047 | 3.0 |
| | | | Dow | 5230 | LLDPE | 4.0 | 0.917 | 56.8 |
| | | | Exxon | PD 4403 E | PP | 7.3 | 0.900 | 14.2 |
| B | 0.132 mils | 15.0% | Ampacet | 1950580 | Black | 7.1 | 1.140 | 25.0 |
| | | | Ampacet | 100458 | Process | 2.5 | 0.960 | 0.5 |
| | | | | | Aid | | | |
| | | | Ampacet | 10545 | Slip AB | 9.5 | 0.928 | 2.0 |
| | | | Ampacet | 10126 | Antiblock | 1.1 | 1.047 | 3.0 |
| | | | Dow | 5230 | LLDPE | 4.0 | 0.917 | 55.6 |
| | | | Exxon | PD 4403 E | PP | 7.3 | 0.900 | 13.9 |

### EXAMPLE 2

A three-layer black-white-black film having a total film thickness of 1.30 mils was produced using the formula set forth in Table 2.

TABLE 2
Formulation 2 - 3 Layer Film Formulation

| | Layer | | | | | Melt | | |
|---|---|---|---|---|---|---|---|---|
| Layer | Thickness | Ratio | Supplier | ID | Type | Index | Density | Content % |
| A | 0.390 mils | 30.0% | Ampacet | 19270 | Black | 13.0 | 1.219 | 10.0 |
| | | | Ampacet | 10545 | Slip AB | 9.5 | 0.928 | 2.0 |
| | | | Ampacet | 302288 | Envirocare | | 1.130 | 1.0 |
| | | | Ampacet | 10126 | Antiblock | 1.1 | 0.917 | 3.0 |
| | | | Dow | 5230 | LLDPE | 4.0 | 0.917 | 67.2 |
| | | | Exxon | PD 4403 E | PP | 7.3 | 0.900 | 16.8 |
| B | 0.780 mils | 60.0% | Ampacet | 1114430 | White | 10.0 | 1.998 | 20.0 |
| | | | Ampacet | 10545 | Slip AB | 9.5 | 0.928 | 2.0 |
| | | | Ampacet | 101949 | UVI | 9.1 | 0.809 | 1.0 |
| | | | Ampacet | 10126 | Antiblock | 1.1 | 1.047 | 3.0 |
| | | | Ampacet | 302288 | Envirocare | | 1.130 | 3.0 |
| | | | Dow | 5230 | LLDPE | 4.0 | 0.917 | 56.8 |
| | | | Exxon | PD 4403 E | PP | 7.3 | 0.900 | 14.2 |
| C | 0.130 mils | 10.0% | Ampacet | 19270 | Black | 13.0 | 1.219 | 20.0 |
| | | | Ampacet | 10545 | Slip AB | 9.5 | 0.928 | 2.0 |
| | | | Ampacet | 302288 | Envirocare | | 1.130 | 3.0 |
| | | | Ampacet | 10126 | Antiblock | 1.1 | 0.917 | 3.0 |
| | | | Dow | 5230 | LLDPE | 4.0 | 0.917 | 57.6 |
| | | | Exxon | PD 4403 E | PP | 7.3 | 0.900 | 14.4 |

### EXAMPLE 3

A two-layer film having a total film thickness of 0.88 mils was produced using the formula set forth in Table 3.

TABLE 3
Formulation 3 - 2 Layer Film Formulation

| | Layer | | | | | Melt | | |
|---|---|---|---|---|---|---|---|---|
| Layer | Thickness | Ratio | Supplier | ID | Type | Index | Density | Content % |
| A | 0.748 mils | 85% | Ampacet | 111443 | White | 10.0 | 1.998 | 20.0 |
| | | | Ampacet | 100458 | Process | 2.5 | 0.960 | 0.5 |
| | | | | | Aid | | | |
| | | | Ampacet | 10545 | Slip AB | 9.5 | 0.928 | 2.0 |
| | | | Ampacet | 101949 | UVI | 9.1 | 0.809 | 1.0 |
| | | | Ampacet | 302288 | Envirocare | | 1.130 | 1.0 |
| | | | | | MB | | | |
| | | | Ampacet | 10126 | Antiblock | 1.1 | 1.047 | 3.0 |
| | | | Dow | 5230 | LLDPE | 4.0 | 0.917 | 58.0 |
| | | | Exxon | PD 4403 E | PP | 7.3 | 0.900 | 14.5 |
| B | 0.132 mils | 15.0% | Ampacet | 190340-D | Black | 4.7 | 1.220 | 16.0 |
| | | | Ampacet | 100458 | Process | 2.5 | 0.960 | 0.5 |
| | | | | | Aid | | | |
| | | | Ampacet | 10545 | Slip AB | 9.5 | 0.928 | 2.0 |
| | | | Ampacet | 10126 | Antiblock | 1.1 | 1.047 | 3.0 |
| | | | Ampacet | 302288 | Envirocare | | 1.130 | 1.0 |
| | | | | | MB | | | |
| | | | Dow | 5230 | LLDPE | 4.0 | 0.917 | 62.0 |
| | | | Exxon | PD 4403 E | PP | 7.3 | 0.900 | 15.5 |

### EXAMPLE 4

A one-layer film for use as a degradable topsheet in black-white-black film laminations having a total film thickness of 0.42 mils was produced using the formula set forth in Table 4.

TABLE 4
Formulation 4 - 1 Layer Film Formulation

| | Layer | | | | | Melt | | |
|---|---|---|---|---|---|---|---|---|
| Layer | Thickness | Ratio | Supplier | ID | Type | Index | Density | Content % |
| A | 0.420 mils | 100% | Ampacet | 190340-D | Black | 4.7 | 1.220 | 10.0 |
| | | | Ampacet | 100458 | Process | 2.5 | 0.960 | 0.5 |
| | | | | | Aid | | | |
| | | | Ampacet | 10545 | Slip AB | 9.5 | 0.928 | 2.0 |
| | | | Ampacet | 302288 | Envirocare | | 1.130 | 1.0 |
| | | | | | MB | | | |
| | | | Ampacet | 10126 | Antiblock | 1.1 | 1.047 | 3.0 |
| | | | Dow | 5230 | LLDPE | 4.0 | 0.917 | 66.8 |
| | | | Exxon | PD 4403 E | PP | 7.3 | 0.900 | 16.7 |

### EXAMPLE 5

A one-layer film for use as a degradable topsheet in black-white-black film laminations having a total film thickness of 0.42 mils was produced using the formula set forth in Table 5.

TABLE 5
Formulation 5 - 1 Layer Film Formulation

| | Layer | | | | | Melt | | |
|---|---|---|---|---|---|---|---|---|
| Layer | Thickness | Ratio | Supplier | ID | Type | Index | Density | Content % |
| A | 0.420 mils | 100% | Ampacet | 190340-D | Black | 4.7 | 1.220 | 10.0 |
| | | | Ampacet | 100458 | Process | 2.5 | 0.960 | 0.5 |
| | | | | | Aid | | | |
| | | | Ampacet | 10545 | Slip AB | 9.5 | 0.928 | 2.0 |
| | | | Ampacet | 302288 | Envirocare | | 1.130 | 7.0 |
| | | | | | MB | | | |
| | | | Ampacet | 10126 | Antiblock | 1.1 | 1.047 | 3.0 |
| | | | Dow | 5230 | LLDPE | 4.0 | 0.917 | 62.0 |
| | | | Exxon | PD 4403 E | PP | 7.3 | 0.900 | 15.5 |

### EXAMPLE 6

A three-layer black-white-black film having a total film thickness of 1.10 mils was produced using the formula set forth in Table 6.

TABLE 6
Formulation 6 - 3 Layer Film Formulation

| | Layer | | | | | Melt | | |
|---|---|---|---|---|---|---|---|---|
| Layer | Thickness | Ratio | Supplier | ID | Type | Index | Density | Content % |
| A | 0.198 mils | 18.0% | Ampacet | 19270 | Black | 13.0 | 1.219 | 20.0 |
| | | | Ampacet | 10545 | Slip AB | 9.5 | 0.928 | 2.0 |
| | | | Ampacet | 302288 | Envirocare | | 1.130 | 1.0 |
| | | | Ampacet | 10126 | Antiblock | 1.1 | 0.917 | 3.0 |
| | | | Ampacet | LR-95508 | UVI | | 0.809 | 0.5 |
| | | | Dow | 5230 | LLDPE | 4.0 | 0.917 | 58.8 |
| | | | Exxon | PD 4403 E | PP | 7.3 | 0.900 | 14.7 |
| B | 0.759 mils | 69.0% | Ampacet | 111443 | White | 10.0 | 1.998 | 20.0 |
| | | | Ampacet | 10545 | Slip AB | 9.5 | 0.928 | 2.0 |
| | | | Ampacet | 101949 | UVI | 9.1 | 0.809 | 1.0 |
| | | | Ampacet | 10126 | Antiblock | 1.1 | 1.047 | 3.0 |
| | | | Ampacet | 302288 | Envirocare | | 1.130 | 3.0 |
| | | | Dow | 5230 | LLDPE | 4.0 | 0.917 | 56.8 |
| | | | Exxon | PD 4403 E | PP | 7.3 | 0.900 | 14.2 |
| C | 0.143 mils | 13.0% | Ampacet | 19270 | Black | 13.0 | 1.219 | 20.0 |
| | | | Ampacet | 10545 | Slip AB | 9.5 | 0.928 | 2.0 |
| | | | Ampacet | 302288 | Envirocare | | 1.130 | 3.0 |
| | | | Ampacet | 10126 | Antiblock | 1.1 | 0.917 | 3.0 |
| | | | Dow | 5230 | LLDPE | 4.0 | 0.917 | 57.6 |
| | | | Exxon | PD 4403 E | PP | 7.3 | 0.900 | 14.4 |

### EXAMPLE 7

A three-layer black-white-black film having a total film thickness of 1.10 mils was produced using the formula set forth in Table 7.

TABLE 7
Formulation 7 - 3 Layer Film Formulation

| | Layer | | | | | Melt | | |
|---|---|---|---|---|---|---|---|---|
| Layer | Thickness | Ratio | Supplier | ID | Type | Index | Density | Content % |
| A | 0.198 mils | 18.0% | Ampacet | 19270 | Black | 13.0 | 1.219 | 20.0 |
| | | | Ampacet | 10545 | Slip AB | 9.5 | 0.928 | 2.0 |
| | | | Ampacet | 302288 | Envirocare | | 1.130 | 1.0 |
| | | | Ampacet | 10126 | Antiblock | 1.1 | 0.917 | 3.0 |
| | | | Ampacet | LR-95508 | UVI | | 0.809 | 0.5 |
| | | | Dow | 5230 | LLDPE | 4.0 | 0.917 | 58.8 |
| | | | Exxon | PD 4403 E | PP | 7.3 | 0.900 | 14.7 |
| B | 0.759 mils | 69.0% | Ampacet | 111443 | White | 10.0 | 1.998 | 20.0 |
| | | | Ampacet | 10545 | Slip AB | 9.5 | 0.928 | 2.0 |
| | | | Ampacet | 101949 | UVI | 9.1 | 0.809 | 1.0 |
| | | | Ampacet | 10126 | Antiblock | 1.1 | 1.047 | 3.0 |
| | | | Ampacet | 302288 | Envirocare | | 1.130 | 3.0 |
| | | | Dow | 5230 | LLDPE | 4.0 | 0.917 | 56.8 |
| | | | Exxon | PD 4403 E | PP | 7.3 | 0.900 | 14.2 |
| C | 0.143 mils | 13.0% | Ampacet | 19270 | Black | 13.0 | 1.219 | 20.0 |
| | | | Ampacet | 10545 | Slip AB | 9.5 | 0.928 | 2.0 |
| | | | Ampacet | 302288 | Envirocare | | 1.130 | 3.0 |
| | | | Ampacet | 10126 | Antiblock | 1.1 | 0.917 | 3.0 |
| | | | Dow | 5230 | LLDPE | 4.0 | 0.917 | 57.6 |
| | | | Exxon | PD 4403 E | PP | 7.3 | 0.900 | 14.4 |

### EXAMPLE 8

A three-layer black-white-black film having a total film thickness of 1.10 mils was produced using the formula set forth in Table 8.

TABLE 8
Formulation 8 - 3 Layer Film Formulation

| | Layer | | | | | Melt | | |
|---|---|---|---|---|---|---|---|---|
| Layer | Thickness | Ratio | Supplier | ID | Type | Index | Density | Content % |
| A | 0.198 mils | 18.0% | Ampacet | 19270 | Black | 13.0 | 1.219 | 20.0 |
| | | | Ampacet | 10545 | Slip AB | 9.5 | 0.928 | 2.0 |
| | | | Ampacet | 302288 | Envirocare | | 1.130 | 7.0 |
| | | | Ampacet | 10126 | Antiblock | 1.1 | 0.917 | 3.0 |
| | | | Dow | 5230 | LLDPE | 4.0 | 0.917 | 54.4 |
| | | | Exxon | PD 4403 E | PP | 7.3 | 0.900 | 13.6 |
| B | 0.759 mils | 69.0% | Ampacet | 111443 | White | 10.0 | 1.998 | 20.0 |
| | | | Ampacet | 10545 | Slip AB | 9.5 | 0.928 | 2.0 |
| | | | Ampacet | 101949 | UVI | 9.1 | 0.809 | 1.0 |
| | | | Ampacet | 10126 | Antiblock | 1.1 | 1.047 | 3.0 |
| | | | Ampacet | 302288 | Envirocare | | 1.130 | 3.0 |
| | | | Dow | 5230 | LLDPE | 4.0 | 0.917 | 56.8 |
| | | | Exxon | PD 4403 E | PP | 7.3 | 0.900 | 14.2 |
| C | 0.143 mils | 13.0% | Ampacet | 19270 | Black | 13.0 | 1.219 | 20.0 |
| | | | Ampacet | 10545 | Slip AB | 9.5 | 0.928 | 2.0 |
| | | | Ampacet | 302288 | Envirocare | | 1.130 | 3.0 |
| | | | Ampacet | 10126 | Antiblock | 1.1 | 0.917 | 3.0 |
| | | | Dow | 5230 | LLDPE | 4.0 | 0.917 | 57.6 |
| | | | Exxon | PD 4403 E | PP | 7.3 | 0.900 | 14.4 |

### EXAMPLE 9

A three-layer black-white-black film having a total film thickness of 1.10 mils was produced using the formula set forth in Table 9.

TABLE 9
Formulation 9 - 3 Layer Film Formulation

| | Layer | | | | | Melt | | |
|---|---|---|---|---|---|---|---|---|
| Layer | Thickness | Ratio | Supplier | ID | Type | Index | Density | Content % |
| A | 0.198 mils | 18.0% | Ampacet | 19270 | Black | 13.0 | 1.219 | 20.0 |
| | | | Ampacet | 10545 | Slip AB | 9.5 | 0.928 | 2.0 |
| | | | Ampacet | 302288 | Envirocare | | 1.130 | 3.0 |
| | | | Ampacet | 10126 | Antiblock | 1.1 | 0.917 | 3.0 |
| | | | Dow | 5230 | LLDPE | 4.0 | 0.917 | 57.6 |
| | | | Exxon | PD 4403 E | PP | 7.3 | 0.900 | 14.4 |
| B | 0.759 mils | 69.0% | Ampacet | 111443 | White | 10.0 | 1.998 | 20.0 |
| | | | Ampacet | 10545 | Slip AB | 9.5 | 0.928 | 2.0 |
| | | | Ampacet | 101949 | UVI | 9.1 | 0.809 | 1.0 |
| | | | Ampacet | 10126 | Antiblock | 1.1 | 1.047 | 3.0 |
| | | | Ampacet | 302288 | Envirocare | | 1.130 | 3.0 |
| | | | Dow | 5230 | LLDPE | 4.0 | 0.917 | 56.8 |
| | | | Exxon | PD 4403 E | PP | 7.3 | 0.900 | 14.2 |
| C | 0.143 mils | 13.0% | Ampacet | 19270 | Black | 13.0 | 1.219 | 20.0 |
| | | | Ampacet | 10545 | Slip AB | 9.5 | 0.928 | 2.0 |
| | | | Ampacet | 302288 | Envirocare | | 1.130 | 3.0 |
| | | | Ampacet | 10126 | Antiblock | 1.1 | 0.917 | 3.0 |
| | | | Dow | 5230 | LLDPE | 4.0 | 0.917 | 57.6 |
| | | | Exxon | PD 4403 E | PP | 7.3 | 0.900 | 14.4 |

### EXAMPLE 10

A three-layer black-white-black film having a total film thickness of 1.10 mils was produced using the formula set forth in Table 10.

TABLE 10
Formulation 10 - 3 Layer Film Formulation

| | Layer | | | | | Melt | | |
|---|---|---|---|---|---|---|---|---|
| Layer | Thickness | Ratio | Supplier | ID | Type | Index | Density | Content % |
| A | 0.198 mils | 18.0% | Ampacet | 19270 | Black | 13.0 | 1.219 | 20.0 |
| | | | Ampacet | 10545 | Slip AB | 9.5 | 0.928 | 2.0 |
| | | | Ampacet | 302288 | Envirocare | | 1.130 | 1.0 |
| | | | Ampacet | 10126 | Antiblock | 1.1 | 0.917 | 3.0 |
| | | | Dow | 5230 | LLDPE | 4.0 | 0.917 | 59.2 |
| | | | Exxon | PD 4403 E | PP | 7.3 | 0.900 | 14.8 |
| B | 0.759 mils | 69.0% | Ampacet | 111443 | White | 10.0 | 1.998 | 20.0 |
| | | | Ampacet | 10545 | Slip AB | 9.5 | 0.928 | 2.0 |
| | | | Ampacet | 101949 | UVI | 9.1 | 0.809 | 1.0 |
| | | | Ampacet | 10126 | Antiblock | 1.1 | 1.047 | 3.0 |
| | | | Ampacet | 302288 | Envirocare | | 1.130 | 3.0 |
| | | | Dow | 5230 | LLDPE | 4.0 | 0.917 | 56.8 |
| | | | Exxon | PD 4403 E | PP | 7.3 | 0.900 | 14.2 |
| C | 0.143 mils | 13.0% | Ampacet | 19270 | Black | 13.0 | 1.219 | 20.0 |
| | | | Ampacet | 10545 | Slip AB | 9.5 | 0.928 | 2.0 |
| | | | Ampacet | 302288 | Envirocare | | 1.130 | 3.0 |
| | | | Ampacet | 10126 | Antiblock | 1.1 | 0.917 | 3.0 |
| | | | Dow | 5230 | LLDPE | 4.0 | 0.917 | 57.6 |
| | | | Exxon | PD 4403 E | PP | 7.3 | 0.900 | 14.4 |

### EXAMPLE 11

A three-layer black-white-black film having a total film thickness of 1.30 mils was produced using the formula set forth in Table 11.

TABLE 11
Formulation 11 - 3 Layer Film Formulation

| | Layer | | | | | Melt | | |
|---|---|---|---|---|---|---|---|---|
| Layer | Thickness | Ratio | Supplier | ID | Type | Index | Density | Content % |
| A | 0.390 mils | 30.0% | Ampacet | 19270 | Black | 13.0 | 1.219 | 10.0 |
| | | | Ampacet | 10545 | Slip AB | 9.5 | 0.928 | 2.0 |
| | | | Ampacet | 302288 | Envirocare | | 1.130 | 7.0 |
| | | | Ampacet | 10126 | Antiblock | 1.1 | 0.917 | 3.0 |
| | | | Dow | 5230 | LLDPE | 4.0 | 0.917 | 62.4 |
| | | | Exxon | PD 4403 E | PP | 7.3 | 0.900 | 15.6 |
| B | 0.780 mils | 60.0% | Ampacet | 111443 | White | 10.0 | 1.998 | 20.0 |
| | | | Ampacet | 10545 | Slip AB | 9.5 | 0.928 | 2.0 |
| | | | Ampacet | 101949 | UVI | 9.1 | 0.809 | 1.0 |
| | | | Ampacet | 10126 | Antiblock | 1.1 | 1.047 | 3.0 |
| | | | Ampacet | 302288 | Envirocare | | 1.130 | 3.0 |
| | | | Dow | 5230 | LLDPE | 4.0 | 0.917 | 56.8 |
| | | | Exxon | PD 4403 E | PP | 7.3 | 0.900 | 14.2 |
| C | 0.130 mils | 10.0% | Ampacet | 19270 | Black | 13.0 | 1.219 | 20.0 |
| | | | Ampacet | 10545 | Slip AB | 9.5 | 0.928 | 2.0 |
| | | | Ampacet | 302288 | Envirocare | | 1.130 | 3.0 |
| | | | Ampacet | 10126 | Antiblock | 1.1 | 0.917 | 3.0 |
| | | | Dow | 5230 | LLDPE | 4.0 | 0.917 | 57.6 |
| | | | Exxon | PD 4403 E | PP | 7.3 | 0.900 | 14.4 |

### EXAMPLE 12

A three-layer black-white-black film having a total film thickness of 1.30 mils was produced using the formula set forth in Table 12.

TABLE 12
Formulation 12 - 3 Layer Film Formulation

| | Layer | | | | | Melt | | |
|---|---|---|---|---|---|---|---|---|
| Layer | Thickness | Ratio | Supplier | ID | Type | Index | Density | Content % |
| A | 0.390 mils | 30.0% | Ampacet | 19270 | Black | 13.0 | 1.219 | 10.0 |
| | | | Ampacet | 10545 | Slip AB | 9.5 | 0.928 | 2.0 |
| | | | Ampacet | 302288 | Envirocare | | 1.130 | 3.0 |
| | | | Ampacet | 10126 | Antiblock | 1.1 | 0.917 | 3.0 |
| | | | Dow | 5230 | LLDPE | 4.0 | 0.917 | 65.6 |
| | | | Exxon | PD 4403 E | PP | 7.3 | 0.900 | 16.4 |
| B | 0.780 mils | 60.0% | Ampacet | 111443 | White | 10.0 | 1.998 | 20.0 |
| | | | Ampacet | 10545 | Slip AB | 9.5 | 0.928 | 2.0 |
| | | | Ampacet | 101949 | UVI | 9.1 | 0.809 | 1.0 |
| | | | Ampacet | 10126 | Antiblock | 1.1 | 1.047 | 3.0 |
| | | | Ampacet | 302288 | Envirocare | | 1.130 | 3.0 |
| | | | Dow | 5230 | LLDPE | 4.0 | 0.917 | 56.8 |
| | | | Exxon | PD 4403 E | PP | 7.3 | 0.900 | 14.2 |
| C | 0.130 mils | 10.0% | Ampacet | 19270 | Black | 13.0 | 1.219 | 20.0 |
| | | | Ampacet | 10545 | Slip AB | 9.5 | 0.928 | 2.0 |
| | | | Ampacet | 302288 | Envirocare | | 1.130 | 3.0 |
| | | | Ampacet | 10126 | Antiblock | 1.1 | 0.917 | 3.0 |
| | | | Dow | 5230 | LLDPE | 4.0 | 0.917 | 57.6 |
| | | | Exxon | PD 4403 E | PP | 7.3 | 0.900 | 14.4 |

### EXAMPLE 13

A three-layer black-white-black film having a total film thickness of 1.10 mils was produced using the formula set forth in Table 13.

TABLE 13
Formulation 13 - 3 Layer Film Formulation

| | Layer | | | | | Melt | | |
|---|---|---|---|---|---|---|---|---|
| Layer | Thickness | Ratio | Supplier | ID | Type | Index | Density | Content % |
| A | 0.198 mils | 18.0% | Ampacet | 19270 | Black | 13.0 | 1.219 | 20.0 |
| | | | Ampacet | 10545 | Slip AB | 9.5 | 0.928 | 2.0 |
| | | | Ampacet | 302288 | Envirocare | | 1.130 | 1.0 |
| | | | Ampacet | 10126 | Antiblock | 1.1 | 0.917 | 3.0 |
| | | | Ampacet | LR-95508 | UVI | | 0.809 | 0.5 |
| | | | Dow | 5230 | LLDPE | 4.0 | 0.917 | 58.8 |
| | | | Exxon | PD 4403 E | PP | 7.3 | 0.900 | 14.7 |
| B | 0.759 mils | 69.0% | Ampacet | 111443 | White | 10.0 | 1.998 | 22.0 |
| | | | Ampacet | 10545 | Slip AB | 9.5 | 0.928 | 2.0 |
| | | | Ampacet | 100840 | UVI/AO | 9.1 | 0.808 | 1.5 |
| | | | Ampacet | 10126 | Antiblock | 1.1 | 1.047 | 3.0 |
| | | | Dow | 5230 | LLDPE | 4.0 | 0.917 | 57.2 |
| | | | Exxon | PD 4403 E | PP | 7.3 | 0.900 | 14.3 |
| C | 0.143 mils | 13.0% | Ampacet | 19270 | Black | 13.0 | 1.219 | 25.0 |
| | | | Ampacet | 10545 | Slip AB | 9.5 | 0.928 | 2.0 |
| | | | Ampacet | 10126 | Antiblock | 1.1 | 0.917 | 3.0 |
| | | | Dow | 5230 | LLDPE | 4.0 | 0.917 | 56.0 |
| | | | Exxon | PD 4403 E | PP | 7.3 | 0.900 | 14.0 |

### EXAMPLE 14

A three-layer black-white-black film having a total film thickness of 1.10 mils was produced using the formula set forth in Table 14.

TABLE 14
Formulation 14 - 3 Layer Film Formulation

| | Layer | | | | | Melt | | |
|---|---|---|---|---|---|---|---|---|
| Layer | Thickness | Ratio | Supplier | ID | Type | Index | Density | Content % |
| A | 0.198 mils | 18.0% | Ampacet | 19270 | Black | 13.0 | 1.219 | 20.0 |
| | | | Ampacet | 10545 | Slip AB | 9.5 | 0.928 | 2.0 |
| | | | Ampacet | 302288 | Envirocare | | 1.130 | 7.0 |
| | | | Ampacet | 10126 | Antiblock | 1.1 | 0.917 | 3.0 |
| | | | Dow | 5230 | LLDPE | 4.0 | 0.917 | 54.4 |
| | | | Exxon | PD 4403 E | PP | 7.3 | 0.900 | 13.6 |
| B | 0.759 mils | 69.0% | Ampacet | 111052 | White | 3.9 | 1.789 | 22.0 |
| | | | Ampacet | 10545 | Slip AB | 9.5 | 0.928 | 2.0 |
| | | | Ampacet | 100840 | UVI/AO | 9.1 | 0.808 | 1.5 |
| | | | Ampacet | 10126 | Antiblock | 1.1 | 1.047 | 3.0 |
| | | | Dow | 5230 | LLDPE | 4.0 | 0.917 | 57.2 |
| | | | Exxon | PD 4403 E | PP | 7.3 | 0.900 | 14.3 |
| C | 0.143 mils | 13.0% | Ampacet | 190580 | Black | 7.10 | 1.140 | 25.0 |
| | | | Ampacet | 10545 | Slip AB | 9.5 | 0.928 | 2.0 |
| | | | Ampacet | 10126 | Antiblock | 1.1 | 0.917 | 3.0 |
| | | | Dow | 5230 | LLDPE | 4.0 | 0.917 | 56.0 |
| | | | Exxon | PD 4403 E | PP | 7.3 | 0.900 | 14.0 |

### EXAMPLE 15

A three-layer black-white-black film having a total film thickness of 1.10 mils was produced using the formula set forth in Table 15.

TABLE 15
Formulation 15 - 3 Layer Film Formulation

| | Layer | | | | | Melt | | |
|---|---|---|---|---|---|---|---|---|
| Layer | Thickness | Ratio | Supplier | ID | Type | Index | Density | Content % |
| A | 0.198 mils | 18.0% | Ampacet | 19270 | Black | 13.0 | 1.219 | 20.0 |
| | | | Ampacet | 10545 | Slip AB | 9.5 | 0.928 | 2.0 |
| | | | Ampacet | 302288 | Envirocare | | 1.130 | 3.0 |
| | | | Ampacet | 10126 | Antiblock | 1.1 | 0.917 | 3.0 |
| | | | Dow | 5230 | LLDPE | 4.0 | 0.917 | 57.6 |
| | | | Exxon | PD 4403 E | PP | 7.3 | 0.900 | 14.4 |
| B | 0.759 mils | 69.0% | Ampacet | 111052 | White | 3.90 | 1.789 | 22.0 |
| | | | Ampacet | 10545 | Slip AB | 9.5 | 0.928 | 2.0 |
| | | | Ampacet | 100840 | UVI/AO | 9.1 | 0.808 | 1.5 |
| | | | Ampacet | 10126 | Antiblock | 1.1 | 1.047 | 3.0 |
| | | | Dow | 5230 | LLDPE | 4.0 | 0.917 | 57.2 |
| | | | Exxon | PD 4403 E | PP | 7.3 | 0.900 | 14.3 |
| C | 0.143 mils | 13.0% | Ampacet | 190580 | Black | 7.1 | 1.140 | 25.0 |
| | | | Ampacet | 10545 | Slip AB | 9.5 | 0.928 | 2.0 |
| | | | Ampacet | 10126 | Antiblock | 1.1 | 0.917 | 3.0 |
| | | | Dow | 5230 | LLDPE | 4.0 | 0.917 | 56.0 |
| | | | Exxon | PD 4403 E | PP | 7.3 | 0.900 | 14.0 |

### EXAMPLE 16

A three-layer black-white-black film having a total film thickness of 1.10 mils was produced using the formula set forth in Table 16.

TABLE 16
Formulation 16 - 3 Layer Film Formulation

| | Layer | | | | | Melt | | |
|---|---|---|---|---|---|---|---|---|
| Layer | Thickness | Ratio | Supplier | ID | Type | Index | Density | Content % |
| A | 0.198 mils | 18.0% | Ampacet | 19270 | Black | 13.0 | 1.219 | 20.0 |
| | | | Ampacet | 10545 | Slip AB | 9.5 | 0.928 | 2.0 |
| | | | Ampacet | 302288 | Envirocare | | 1.130 | 1.0 |
| | | | Ampacet | 10126 | Antiblock | 1.1 | 0.917 | 3.0 |
| | | | Dow | 5230 | LLDPE | 4.0 | 0.917 | 59.2 |
| | | | Exxon | PD 4403 E | PP | 7.3 | 0.900 | 14.8 |
| B | 0.759 mils | 69.0% | Ampacet | 111052 | White | 3.90 | 1.789 | 22.0 |
| | | | Ampacet | 10545 | Slip AB | 9.5 | 0.928 | 2.0 |
| | | | Ampacet | 100840 | UVI/AO | 9.1 | 0.808 | 1.5 |
| | | | Ampacet | 10126 | Antiblock | 1.1 | 1.047 | 3.0 |
| | | | Dow | 5230 | LLDPE | 4.0 | 0.917 | 57.2 |
| | | | Exxon | PD 4403 E | PP | 7.3 | 0.900 | 14.3 |
| C | 0.143 mils | 13.0% | Ampacet | 190580 | Black | 7.1 | 1.140 | 25.0 |
| | | | Ampacet | 10545 | Slip AB | 9.5 | 0.928 | 2.0 |
| | | | Ampacet | 10126 | Antiblock | 1.1 | 0.917 | 3.0 |
| | | | Dow | 5230 | LLDPE | 4.0 | 0.917 | 56.0 |
| | | | Exxon | PD 4403 E | PP | 7.3 | 0.900 | 14.0 |

### EXAMPLE 17

A three-layer black-white-black film having a total film thickness of 1.30 mils was produced using the formula set forth in Table 17.

TABLE 17
Formulation 17 - 3 Layer Film Formulation

| | Layer | | | | | Melt | | |
|---|---|---|---|---|---|---|---|---|
| Layer | Thickness | Ratio | Supplier | ID | Type | Index | Density | Content % |
| A | 0.390 mils | 30.0% | Ampacet | 19270 | Black | 13.0 | 1.219 | 10.0 |
| | | | Ampacet | 10545 | Slip AB | 9.5 | 0.928 | 2.0 |
| | | | Ampacet | 302288 | Envirocare | | 1.130 | 3.0 |
| | | | Ampacet | 10126 | Antiblock | 1.1 | 0.917 | 3.0 |
| | | | Dow | 5230 | LLDPE | 4.0 | 0.917 | 65.6 |
| | | | Exxon | PD 4403 E | PP | 7.3 | 0.900 | 16.4 |
| B | 0.780 mils | 60.0% | Ampacet | 111052 | White | 3.90 | 1.789 | 22.0 |
| | | | Ampacet | 10545 | Slip AB | 9.5 | 0.928 | 2.0 |
| | | | Ampacet | 100840 | UVI/AO | 9.1 | 0.808 | 1.5 |
| | | | Ampacet | 10126 | Antiblock | 1.1 | 1.047 | 3.0 |
| | | | Dow | 5230 | LLDPE | 4.0 | 0.917 | 57.2 |
| | | | Exxon | PD 4403 E | PP | 7.3 | 0.900 | 14.3 |
| C | 0.130 mils | 10.0% | Ampacet | 190580 | Black | 7.1 | 1.140 | 25.0 |
| | | | Ampacet | 10545 | Slip AB | 9.5 | 0.928 | 2.0 |
| | | | Ampacet | 10126 | Antiblock | 1.1 | 0.917 | 3.0 |
| | | | Dow | 5230 | LLDPE | 4.0 | 0.917 | 56.0 |
| | | | Exxon | PD 4403 E | PP | 7.3 | 0.900 | 14.0 |

### EXAMPLE 18

A three-layer black-white-black film having a total film thickness of 1.30 mils was produced using the formula set forth in Table 18.

TABLE 18
Formulation 18 - 3 Layer Film Formulation

| | Layer | | | | | Melt | | |
|---|---|---|---|---|---|---|---|---|
| Layer | Thickness | Ratio | Supplier | ID | Type | Index | Density | Content % |
| A | 0.390 mils | 30.0% | Ampacet | 19270 | Black | 13.0 | 1.219 | 10.0 |
| | | | Ampacet | 10545 | Slip AB | 9.5 | 0.928 | 2.0 |
| | | | Ampacet | 302288 | Envirocare | | 1.130 | 7.0 |
| | | | Ampacet | 10126 | Antiblock | 1.1 | 0.917 | 3.0 |
| | | | Dow | 5230 | LLDPE | 4.0 | 0.917 | 62.4 |
| | | | Exxon | PD 4403 E | PP | 7.3 | 0.900 | 15.6 |
| B | 0.780 mils | 60.0% | Ampacet | 111052 | White | 3.90 | 1.789 | 22.0 |
| | | | Ampacet | 10545 | Slip AB | 9.5 | 0.928 | 2.0 |
| | | | Ampacet | 100840 | UVI/AO | 9.1 | 0.808 | 1.5 |
| | | | Ampacet | 10126 | Antiblock | 1.1 | 1.047 | 3.0 |
| | | | Dow | 5230 | LLDPE | 4.0 | 0.917 | 57.2 |
| | | | Exxon | PD 4403 E | PP | 7.3 | 0.900 | 14.3 |
| C | 0.130 mils | 10.0% | Ampacet | 190580 | Black | 7.1 | 1.140 | 25.0 |
| | | | Ampacet | 10545 | Slip AB | 9.5 | 0.928 | 2.0 |
| | | | Ampacet | 10126 | Antiblock | 1.1 | 0.917 | 3.0 |
| | | | Dow | 5230 | LLDPE | 4.0 | 0.917 | 56.0 |
| | | | Exxon | PD 4403 E | PP | 7.3 | 0.900 | 14.0 |

### EXAMPLE 19

A three-layer black-white-black film having a total film thickness of 1.30 mils was produced using the formula set forth in Table 19.

TABLE 19
Formulation 19 - 3 Layer Film Formulation

| | Layer | | | | | Melt | | |
|---|---|---|---|---|---|---|---|---|
| Layer | Thickness | Ratio | Supplier | ID | Type | Index | Density | Content % |
| A | 0.390 mils | 30.0% | Ampacet | 19270 | Black | 13.0 | 1.219 | 10.0 |
| | | | Ampacet | 10545 | Slip AB | 9.5 | 0.928 | 2.0 |
| | | | Ampacet | 302288 | Envirocare | | 1.130 | 1.0 |
| | | | Ampacet | 10126 | Antiblock | 1.1 | 0.917 | 3.0 |
| | | | Dow | 5230 | LLDPE | 4.0 | 0.917 | 67.2 |
| | | | Exxon | PD 4403 E | PP | 7.3 | 0.900 | 16.8 |
| B | 0.780 mils | 60.0% | Ampacet | 111052 | White | 3.90 | 1.789 | 22.0 |
| | | | Ampacet | 10545 | Slip AB | 9.5 | 0.928 | 2.0 |
| | | | Ampacet | 100840 | UVI/AO | 9.1 | 0.808 | 1.5 |
| | | | Ampacet | 10126 | Antiblock | 1.1 | 1.047 | 3.0 |
| | | | Dow | 5230 | LLDPE | 4.0 | 0.917 | 57.2 |
| | | | Exxon | PD 4403 E | PP | 7.3 | 0.900 | 14.3 |
| C | 0.130 mils | 10.0% | Ampacet | 190580 | Black | 7.1 | 1.140 | 25.0 |
| | | | Ampacet | 10545 | Slip AB | 9.5 | 0.928 | 2.0 |
| | | | Ampacet | 10126 | Antiblock | 1.1 | 0.917 | 3.0 |
| | | | Dow | 5230 | LLDPE | 4.0 | 0.917 | 56.0 |
| | | | Exxon | PD 4403 E | PP | 7.3 | 0.900 | 14.0 |

1. (canceled)

2. (canceled)

3. The film of claim 24 wherein at least one of said first layer or said second layer comprises from about 50-99% by weight of said at least one polyolefin polymer.

4. The film of claim 3 wherein said polyolefin polymer is selected from the group consisting of polyethylene, polypropylene, polybutenes, polyisoprene, copolymers thereof, terpolymers thereof, α-olefin propylene copolymers, metallocene-catalyzed polyolefin resins, and mixtures thereof.

5. The film of claim 4 wherein said polyolefin polymer is selected from the group consisting of linear low density polyethylene, low density polyethylene, high density polyethylene, ultra low density polyethylene, and mixtures thereof.

6. (canceled)

7. The film of claim 24 wherein at least one of said first layer or said second layer comprises from about 0.1-10% by weight of said degradable additive.

8. The film of claim 24 wherein said degradable additive of at least one of said first layer or said second layer comprises at least one metal carboxylate and at least one aliphatic poly hydroxy-carboxyl acid.

9. (canceled)

10. The film of claim 24 wherein at least one of said first layer or said second layer further comprises an additive selected from the group consisting of neutralizers, process aids, lubricants, stabilizers, hydrocarbon resins, antistatics, antiblocking agents, slip agents, fillers, ultraviolet stabilizers, specialty additives and mixtures thereof.

11. The film of claim 10 wherein at least one of said first layer or said second layer comprises from about 0-80% by weight of said additive.

12. (canceled)

13. (canceled)

14. The film of claim 24 wherein said film comprises at least 3 or more layers wherein each layer comprises a different colorant.

15. (Originally Omitted)

16. The film of claim 24 wherein said film further comprises a tie layer.

17. The film of claim 24 wherein said film has a thickness of up to about 15 mils.

18. The film of claim 24 wherein said film has a thickness of from about 0.5-15 mils.

19. The film of claim 24 wherein at least one of said first layer and said second layer has a thickness of from about 0.1-15 mils.

20. The film of claim 24 wherein said at least one of said first layer or said second layer has a thickness of from about 0.1-7.0 mils.

21. The film of claim 24 wherein said film is photodegradable.

22. The film of claim 24 wherein said film is thermally degradable.

23. The film of claim 24 wherein at least one of said first layer or said second layer further comprises at least one soil nutrients or at least one fertilizer.

24. A multi-layer degradable film comprising:
a first layer comprising from about 0.5-99% by weight of at least one polyolefin polymer, from about 0.1-49% by weight of a degradable additive, and from about 0.1-49% by weight of a colorant; and
a second layer comprising from about 0.5-99% by weight of at least one polyolefin polymer, from about 0.1-49% by weight of a degradable additive, and from about 0.1-49% by weight of a colorant that is different from the colorant in the first layer.

25. The film of claim 24 wherein the second layer degrades at a different rate than the first layer.
